(19) United States
(12) Patent Application Publication
(10) Pub. No.: US 2007/0189572 A1
(43) Pub. Date: Aug. 16, 2007

(54) LOUDSPEAKER SYSTEM FOR ACOUSTIC INSTRUMENTS AND METHOD THEREFOR

(76) Inventor: Eugene Stanley Juall, Las Vegas, NV (US)

Correspondence Address: WEISS & MOY PC, 4204 NORTH BROWN AVENUE, SCOTTSDALE, AZ, 85251, US

(21) Appl. No.: 11/627,447

(22) Filed: Jan. 26, 2007

Related U.S. Application Data
(60) Provisional application No. 60/763,495, filed on Jan. 30, 2006.

(51) Int. Cl. H04R 9/06; H04R 11/02; H04R 1/00

(52) U.S. Cl. 381/396; 381/423; 381/400

(57) ABSTRACT

A speaker cabinet including at least one bass speaker having a voice coil aligned by a magnetic fluid without a ‘spider’ and having an anodised metal cone, and at least one further speaker having a thin conductive membrane, and having integrated preamplifiers and at least one power amplifier, for use with musical instruments, for playing small to medium sized venues and/or for use as a personal monitor speaker on a performance stage for playing medium to large venues. Multiple channels are provided to amplify more than one instrument, and microphone inputs are provided for acoustic instruments and/or voice amplification. A line level input is also provided for external signal sources. An auxiliary input is provided to facilitate the monitoring of accompanying musicians, thus permitting the loudspeaker system to also function as a stage monitor. Reverberation and notch filtering, as well as tone control, may also be provided.

### RELATED APPLICATION

This application is related to U.S. Provisional Application Ser. No. 60/763,495, filed Jan. 30, 2006, in the name of the same inventor listed above, and entitled, “AccuSonic-One Acoustic Instrument Cabinet”. The present patent application claims the benefit under 35 U.S.C. §119(e).

### FIELD OF THE INVENTION

The invention relates to speaker enclosures for audio reproduction and, more particularly, to a novel arrangement of speakers integrated with a preamplifier and a power amplifier to form an acoustic instrument cabinet with improved performance.

### BACKGROUND OF THE INVENTION

Musicians playing small to medium sized venues typically must transport a variety of electronic equipment to the venue in addition to their instruments. Even if an integrated power amplifier and speaker is available, separate equipment may be needed for special effects. In addition, a preamplifier may be needed with acoustic instruments for the signal from a microphone or pick-up to drive a power amplifier.

While there exists prior art examples of musical instrument equipment that combine a number of the above described elements; a problem with current equipment concerns the ‘spider’ usually used as a mechanical support for the voice coil in loudspeakers. The spider acts as a small speaker cone itself, and tends to generate unwanted vibrations.

Therefore, a need exists to provide a device and method to overcome the above problem.

### SUMMARY OF THE INVENTION

A speaker cabinet including a bass speaker having a voice coil aligned by a magnetic fluid without a ‘spider’ and having an anodised metal cone, and a further speaker having a metal ribbon, and having integrated preamplifiers and power amplifier, for use with musical instruments, for playing small to medium sized venues and/or for use as a personal monitor speaker on a performance stage for playing medium to large venues. Multiple channels are provided to amplify more than one instrument, and a microphone input is provided for acoustic instruments and/or voice amplification. A line level input is provided for external signal sources. An auxiliary input is provided to facilitate the monitoring of accompanying musicians, thus permitting the loudspeaker to function as a stage monitor. Reverberation and notch filtering, as well as tone control, may also be provided.

The present invention is best understood by reference to the following detailed description when read in conjunction with the accompanying drawings.

### BRIEF DESCRIPTION OF THE DRAWINGS

FIG. 1 is a bass speaker according to a preferred embodiment of the invention.

FIG. 2A is a cross-sectional side view of a first side of a speaker cabinet according to a preferred embodiment of the invention.

FIG. 2B is a second side view of a speaker cabinet according to a preferred embodiment of the invention.

FIG. 3 is a front view of a speaker cabinet according to a preferred embodiment of the invention.

FIG. 4 is a schematic of a preamplifier circuit.

FIG. 5 shows connections for input jacks and for gain control and tone control potentiometers according to a preferred embodiment of the invention.

FIG. 6 shows an effects insertion circuit according to a preferred embodiment of the invention.

FIG. 7 shows a socket, switch and resistors for an internal effects module according to a preferred embodiment of the invention.

FIG. 8 shows an active notch filter according to a preferred embodiment of the invention.

FIG. 9 shows an output driver circuit according to a preferred embodiment of the invention.

FIG. 10 shows an exemplary power supply regulation circuit according to a preferred embodiment of the invention.

Common reference numerals are used throughout the drawings and detailed description to indicate like elements.

### DETAILED DESCRIPTION

A speaker cabinet according to a preferred embodiment of the invention is provided with inputs for two musical instruments (channel 1 and channel 2) and an input for a microphone input and a line level input. In addition, an active notch filter is provided in channel 1, and tone controls are provided in both channels, and a power amplifier is provided to drive a bass speaker driver and a speaker driver for high frequencies and mid range. The high frequency/mid-range speaker driver preferably employs a planar magnetic driver, preferably of a neodymium ribbon type. The speaker cabinet provides enhanced functionality. The speaker cabinet can be utilized either as a musician personal instrument cabinet/monitor or as a self contained high quality sound reinforcement system capable of reproducing the sound of two instruments, a microphone and a line level signal source simultaneously.

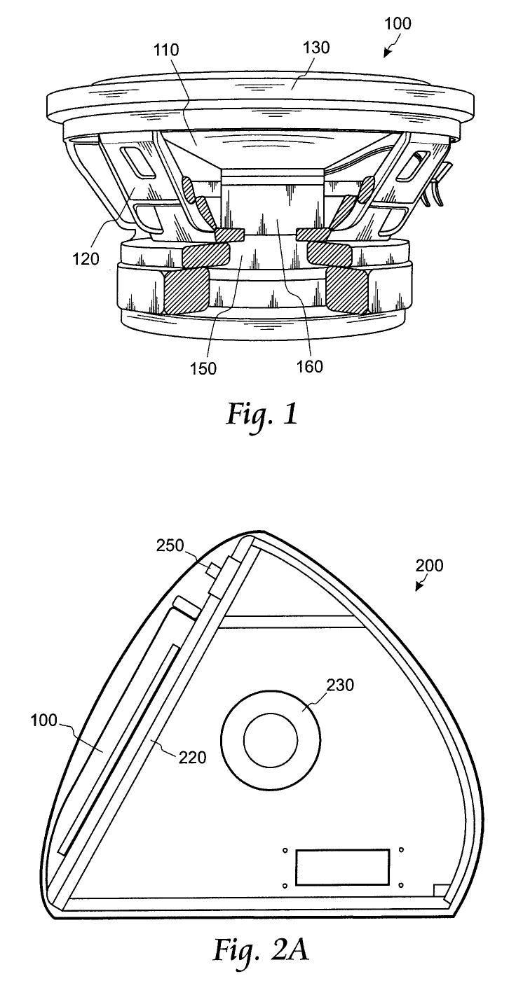

Referring to FIG. 1, a speaker driver 100 is shown. The speaker 100 has a diaphragm 110, a basket 120, a surround 130, a magnet 140 and a voice coil 150. Diaphragm 110 is preferably made of metal, preferably aluminium, and is preferably anodised. Applicant has found that anodising the diaphragm 110 improves strength and reduces unwanted vibration. Basket 120 is preferably made by casting. Surround 130 may be made of a suitable composite material. The space 160 around the voice coil 150 is filled with a magnetic fluid known as a ferrofluid. The magnetic fluid provides a means of centering the voice coil 150 relative to the magnet 140. Unlike in conventional designs, no mechanical alignment device or ‘spider’ is employed between the voice coil and the magnet. The elimination of the ‘spider’ will remove unwanted vibrations.

In general, most prior art speakers cannot reproduce the entire frequency spectrum on their own. Therefore, these speaker systems must use multiple speaker drivers fed by distinct frequency ranges split up through a crossover. Since this process most certainly leads to some degree of signal degradation, it is desirable to minimize the number of cross-over frequency points to as few as possible. The present loudspeaker cabinet's unique combination of planar magnetic drivers and spider-less cone type drivers provides for improved acoustic performance.

The speaker cabinet of the present invention will use multiple speaker drivers 100. The speaker cabinet will have a planar magnetic driver for mid and high frequency ranges and a spiderless conical voice coil driver for low frequency reproduction. Planar magnetic drivers are very light weight thereby reducing the overall weight of the speaker cabinet. Planar-magnetic drivers work by having a thin conductive membrane that carries the audio signal, suspended between strong magnets. When the audio signal passes through the conductive membrane, this sets up a magnetic field that is attracted or repelled by the permanent magnets. The membrane moves, creating the sound heard. It should be noted that one or more planar magnetic drivers may be used for different mid and high frequency ranges. It also should be noted that one or more spiderless conical voice coil drivers can be used for low frequencies.

The combination of the one or more planar magnetic drivers for mid and high frequency ranges and one or more spiderless conical voice coil drivers for low frequency reproduction will provide for a high performance speaker cabinet in terms of frequency response, waveform accuracy, transient response and overall dynamic range.

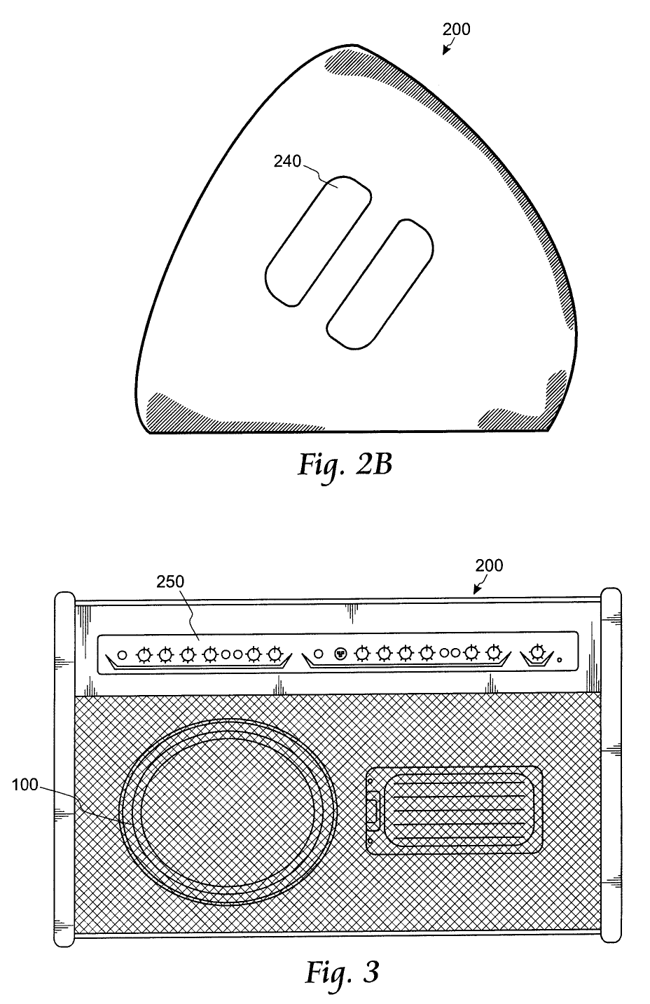

Referring to FIGS. 2A-2B, side views of the speaker cabinet 200 are shown. The speaker cabinet 200 is generally constructed of a wood material. The speaker cabinet 200 is generally shaped with a flat bottom section and a curved/rounded back section. The speaker cabinet 200 has a partition 210 and a double baffle 220 supporting multiple speaker drivers 100 and a control panel 250. An opening 230 is formed in one side of the speaker cabinet 200. Opening 230 is used as a pole mount. One or more elongated openings 240 are formed on a second side of the speaker cabinet 200. The elongated openings 240 are used has hand grips to allow a person to grasp the speaker cabinet 200 in a secure manner in order to move the speaker cabinet 200.

FIG. 3 is a front view of the speaker cabinet 200 of FIG. 2 showing the location of the speaker driver 100 and control panel 250 in the speaker cabinet 200.

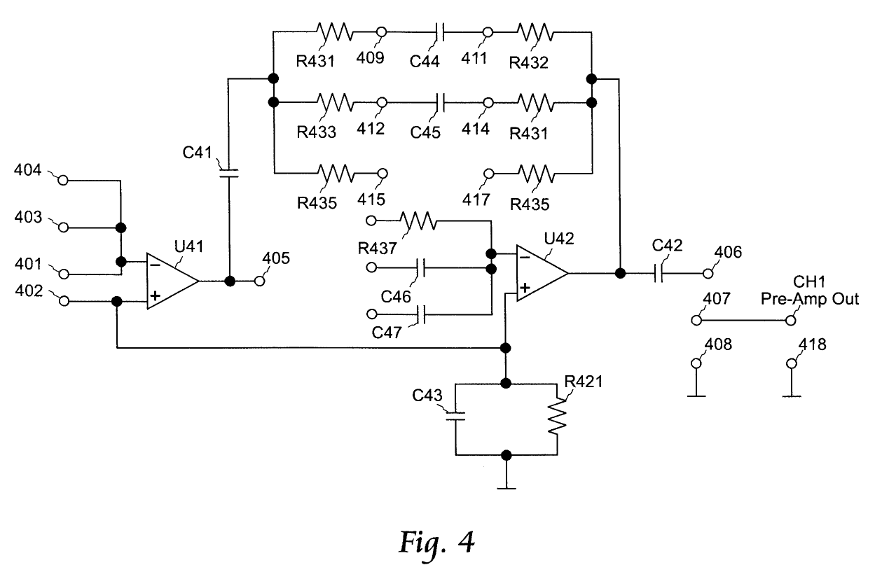

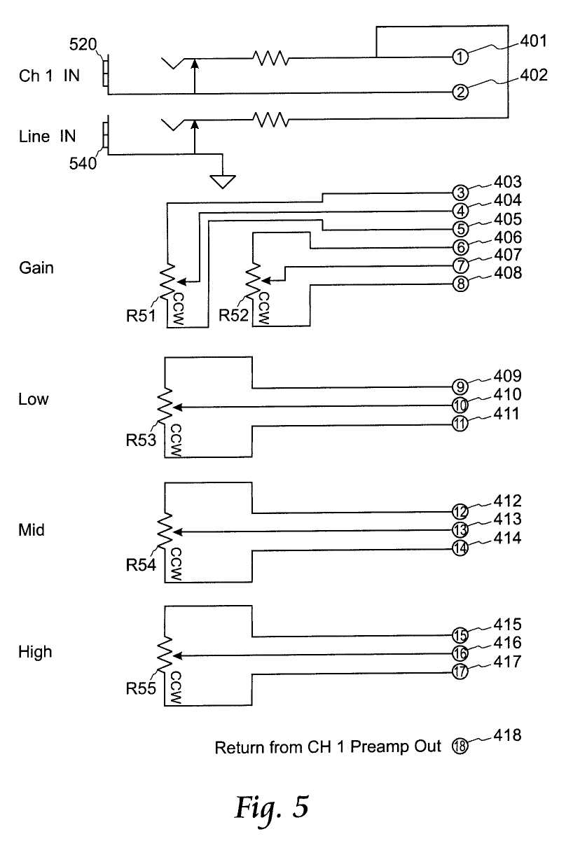

FIG. 4 shows one embodiment of a preamplifier circuit for channel 1. A similar circuit may be employed for channel 2. FIG. 4 is just one example of a preamplifier circuit. Other preamplifer circuits may be used without departing from the spirit and scope of the present invention. The preamplifier circuit of FIG. 4 comprises amplifier stages U41, U42 with capacitors C41, C42, C43 and resistor R421, and tone control components comprising C44-C47 and R431-R437. FIG. 5 shows connections for input jacks 520 and 540 for channel 1 input and line input, and for the gain control potentiometer R51 as well as tone control potentiometers R53, R54 and R55 for low, mid and high frequency ranges respectively. Connections 401-418 connect the components of FIG. 4 with those of FIG. 5. A similar arrangement can be provided for channel 2.

In accordance with another embodiment of the present invention, a tube preamplifier circuit may be used instead of a solid state preamplifier circuit disclosed above. The tube preamplifier circuit adds unique tonal qualities generally preferred by musicians for stringed instruments such as acoustic guitars. The tube preamplifier circuit would plug into and thus be inserted between the instrument input jack and the solid state circuitry. Alternatively, the tube preamplifier circuit could replace the solid state preamplifier circuit in the speaker cabinet.

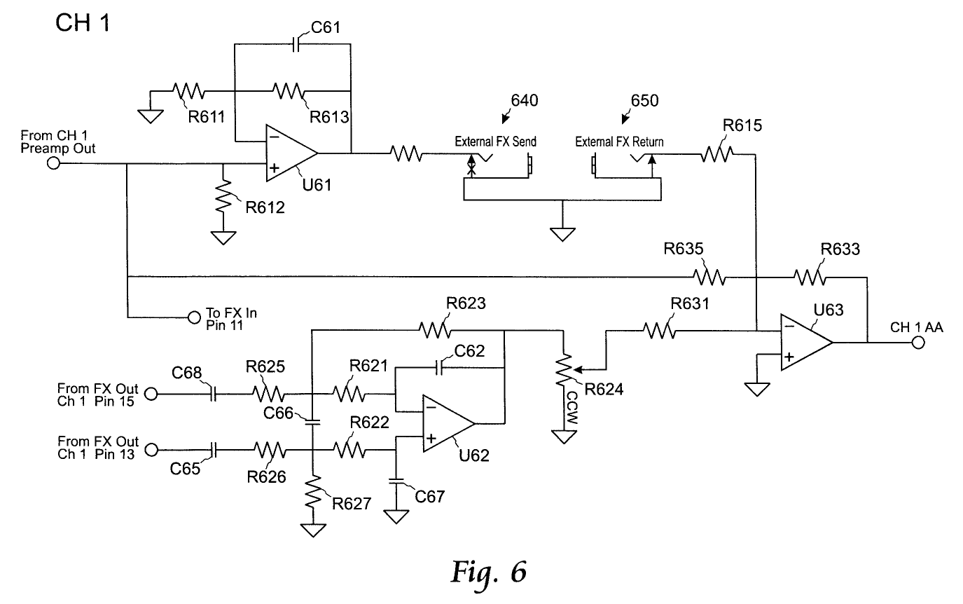

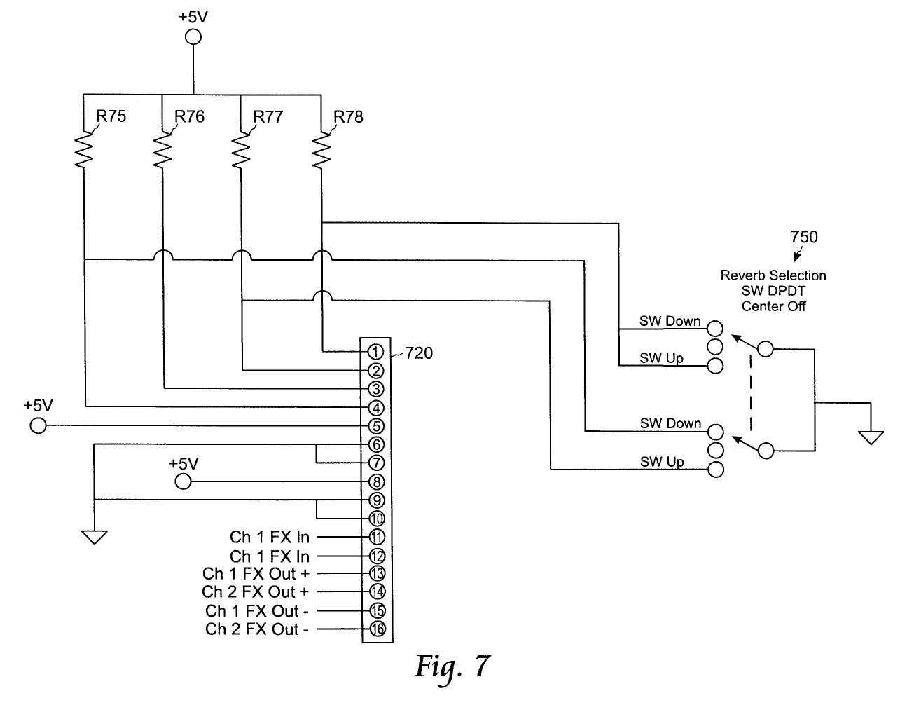

FIG. 6 shows an effects insertion circuit according to one embodiment of the invention. The circuit shown is for channel 1, and a similar circuit can be employed for channel 2. Other insertion and/or selection circuits may be used without departing from the spirit and scope of the present invention. The input of the circuit of FIG. 6 is connected to the output of the channel 1 preamplifier and to the channel 1 effects input pin (pin 11) of socket 720 in FIG. 7. The input stage comprises amplifier U61, the non-inverting input of which is driven by a channel 1 pre-amplifier and has R612 connected in shunt. U61 is provided with a feedback network comprising R611, R613 and C61, and is connected via resistor R614 to jack 640. An external effects unit can be connected between jack 640 and jack 650, and jack 650 is connected via resistor R615 to the non-inverting input of amplifier U63 in the output stage. U63 is also provided with feedback resistor R633. When no external effects unit is connected between jacks 640 and 650, the audio signal is passed through, unimpeded. In addition, the signal from the preamplifier is also fed directly to the inverting input of U63 via R635. In addition to being fed to the non-inverting input of U63, the signal taken from the junction of R615 and R635 is also fed via fixed resistor R631, variable resistor R624 and fixed resistor R623 to a network comprising C64, C65, C66, R625, R626 and R627 to effects output pins 15 and 13 of socket 720 shown in FIG. 7. The voltage across C66 is also fed back via R621 and R622 to the inputs of U62, which is also provided with feedback capacitor C62 and with C67 in shunt with the non-inverting input. The output of U62 is then fed back to the junction of R623 and R624. FIG. 7 comprises socket 720, switch 750 and resistors R75-78.

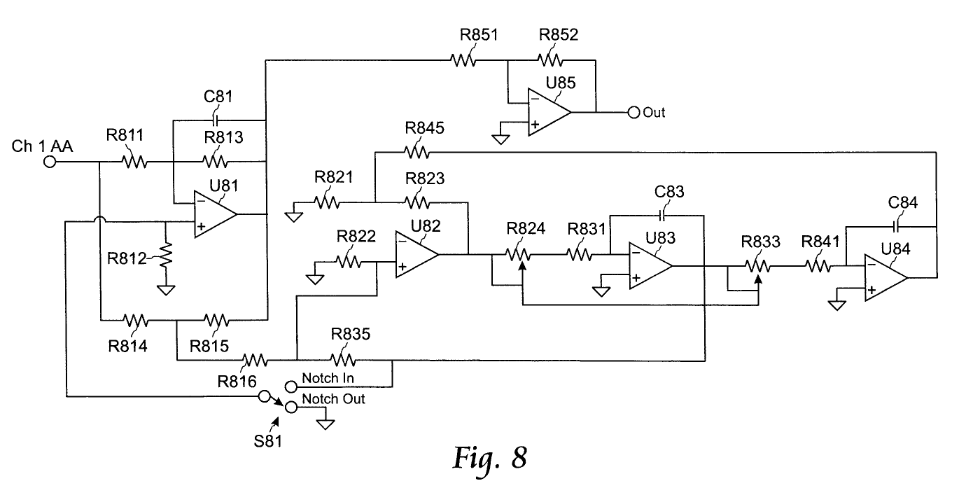

FIG. 8 shows an active notch filter according to a one embodiment of the invention. Other designs may be used for the notch filter without departing from the spirit and scope of the present invention. The filter of FIG. 8 employs an input amplifier U81 with input resistors R811 and R812, feedback resistor R813 and capacitor C81, and an output amplifier U85 with input resistor R851 and feedback resistor R852. The notch filter can be switched out by switch S81 grounding the positive input of U81. When the non-inverting input of U81 is not grounded, it is connected to the output of U83. A signal is taken from the junction of R814 and R815 and fed via R816 to the non-inverting input of U82, the inputs of which are grounded via R821 and R822, and which is provided with feedback resistor R823. The output of U82 is fed via R824 and R831 to the inverting input of U83, which has capacitor C83 in it's feedback loop. The output of U83 is fed via R833 and R841 to the negative input of U84, which has feedback capacitor C84, and the output of which is fed back to the negative input of U82 via R845. The output of U83 is also fed back to the positive input of U82 via R835. R824 and R833 are variable resistors and are ganged together with each other.

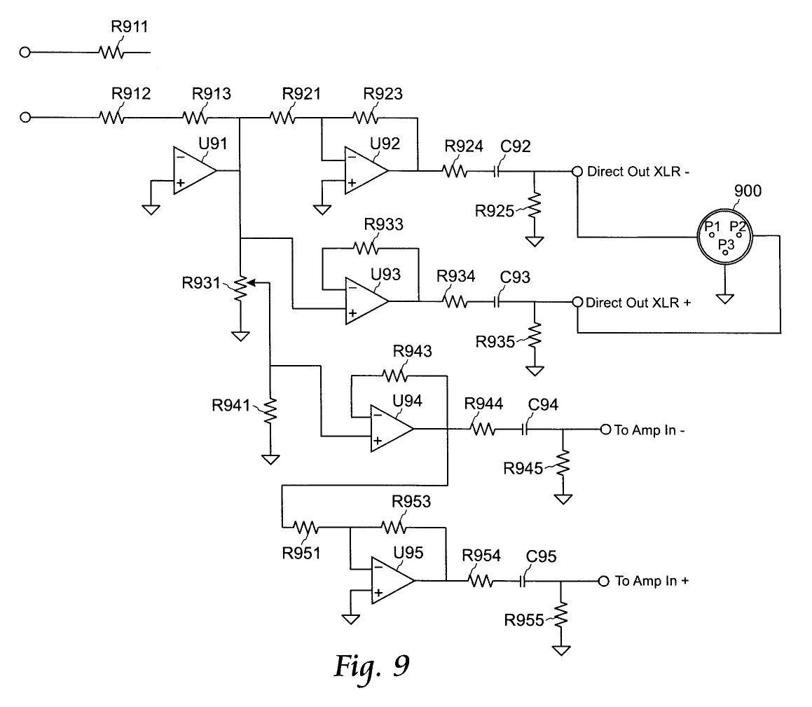

FIG. 9 shows an output driver circuit according to a one embodiment of the invention. Other driver circuits may be used without departing from the spirit and scope of the present invention. Signals from channel 1 and channel 2 are combined at the inverting input of amplifier U91 via resistors R911 and R912. Amplifier U91 is also provided with negative feedback via resistor R913. The output of amplifier U91 is fed via amplifiers U92 and U93 to an XLR connector 900, and via amplifiers U94 and U95 to a power amplifier. More specifically, the output of U91 is fed via resistor R921 to the inverting input of U92 and also fed to the non-inverting input of U93. Amplifiers U92 and U93 are provided with feedback resistors R923, R933, series output resistors R924, R934, output capacitors C92, C93 and shunt output resistors R925, R935 respectively. Similarly, the output of U91 is fed via variable resistor R931 and fixed resistor R941 to the non-inverting input of U94, which is provided with feedback resistor R943. The output of U93 is fed via the output network comprising R944, C94, R945 to the negative input of the power amplifier, and also via resistor R951 to the inverting input of U95. Amplifier U95 is provided with feed back resistor R953 and the output of U95 is fed via output network R954, C95, R955 to the positive input of the power amplifier.

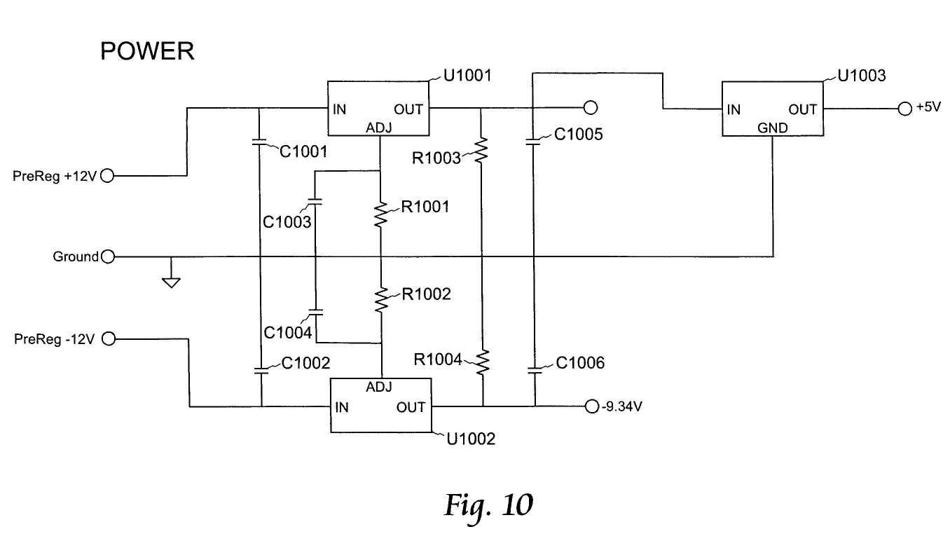

An exemplary power supply regulation circuit is shown in FIG. 10, comprising regulators U1001, U1002 and U1003, capacitors C1001-C1005 and resistors R1001-R1004. Other suitable supply regulation means may of course be employed.

In a preferred embodiment the signal flow from the input jacks goes via preamplifier stages to the circuit of FIG. 6 and to a similar circuit for channel 2, then the channel 1 signal only is passed through the circuit of FIG. 8, and then both channels go to the circuit of FIG. 9 to the direct output jack and to the power amplifier. The amplifier stages shown in the drawings may be operational or differential amplifiers of any suitable type, or may be substituted with discrete bipolar transistors, FETs, vacuum tubes or other active devices with the addition of suitable additional passive components. Any suitable crossover circuit may be employed to divide the output of the power amplifier between the different frequency range loudspeakers. Or, any suitable crossover circuit may be employed at the output of the preamplifier; so as to provide separate audio signals, low frequency and high frequency, to facilitate the use of individual power amplifiers for the low and high frequencies.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A musical instrument loudspeaker system, comprising:
a cabinet;
at least one planar magnetic driver for mid and high frequency sound signals mounted in the cabinet; and
at least one conical voice coil driver for low frequency mounted in the cabinet.

2. A musical instrument loudspeaker system in accordance with claim 1 wherein the conical voice coil driver comprising:
a voice coil;
a magnet;
a cone; and
a ferrofluid interposed between said voice coil and said magnet, said ferrofluid constituting an alignment means for aligning said voice coil with said magnet.

3. A musical instrument loudspeaker system in accordance with claim 2 wherein said cone comprises metal.

4. A musical instrument loudspeaker system in accordance with claim 3, wherein said cone comprises one a lightweight and rigid carbon-fiber, composite honeycomb-aluminum, honeycomb-polymer, Kevlar™, paper, polycarbonate, or a combination thereof.

5. A musical instrument loudspeaker system in accordance with claim 3, wherein said cone is anodised.

6. A musical instrument loudspeaker system in accordance with claim 1, wherein said planar magnetic driver comprises a neodymium ribbon driver.

7. A musical instrument loudspeaker system in accordance with claim 1, further comprising:
a power amplifier integrated therein for driving said planar magnetic driver and said conical voice coil driver; and
a preamplifier having a plurality of inputs and integrated therein for driving said power amplifier.

8. A loudspeaker system comprising:
a cabinet at least one speaker unit mounted in said cabinet;
at least one power amplifier mounted in said cabinet for driving said at least one speaker unit; and
at least one preamplifier mounted in said cabinet for driving said power amplifier,
whereby at least one acoustic instrument may adequately drive said speaker unit.

9. The loudspeaker system according to claim 8, wherein said at least one preamplifier is provided with a plurality of inputs.

10. The loudspeaker system according to claim 9, wherein said at least one preamplifier is provided with tone controls adjustable by a user.

11. The loudspeaker system according to claim 8, further comprising reverberation means configured to be driven by said at least one preamplifier and to drive said power amplifier.

12. The loudspeaker system according to claim 8, further comprising a notch filter configured to be driven by said at least one preamplifier and to drive said power amplifier.

13. The loudspeaker system according to claim 8, wherein said at least one loudspeaker unit comprises a first driver, and said first driver comprising a metal cone.

14. The loudspeaker system according to claim 8, wherein said cone comprises anodised aluminum.

15. The loudspeaker system according to claim 8, wherein said at least one loudspeaker unit comprises a first driver, said first driver comprising:
a magnet and a voice coil; and
a ferrofluid interposed between said voice coil and said magnet, said ferrofluid constituting a sole alignment means for aligning said voice coil with said magnet.

16. The loudspeaker system according to claim 15, wherein said at least one loudspeaker unit further comprises a second driver, said second driver having a generally higher frequency range than said first driver, said second driver being a planar magnetic driver.

17. The loudspeaker system according to claim 8, wherein said at least one loudspeaker unit comprises:
a planar magnetic driver for mid and high frequency sound signals mounted in the cabinet; and
a conical voice coil driver for low frequency mounted in the cabinet.

18. The loudspeaker system according to claim 17, wherein said conical voice coil driver comprising:
a voice coil;
a magnet;
a cone; and
a ferrofluid interposed between said voice coil and said magnet, said ferrofluid constituting an alignment means for aligning said voice coil with said magnet.

19. The loudspeaker system according to claim 16, wherein said planar magnetic driver comprises a neodymium ribbon driver.
